(19) United States
(12) Patent Application Publication
(10) Pub. No.: US 2008/0226516 A1
(43) Pub. Date: Sep. 18, 2008

(54) MICROREACTOR SYSTEM

(76) Inventors: Mio Suzuki, Hitachinaka (JP); Shigenori Togashi, Abiko (JP); Tadashi Sano, Ushiku (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 12/018,477

(22) Filed: Jan. 23, 2008

(30) Foreign Application Priority Data
Mar. 12, 2007 (JP) 2007-061185

(51) Int. Cl. B01J 19/00

(52) U.S. Cl. 422/188

(57) ABSTRACT

It is an object of the present invention to ensure quite high-speed and highly efficient production using the microreactors and facilitate transition from laboratory-basis synthesis to industrial production.

A microreactor system collecting a mixture solution obtained by mixing up material solutions in a microreactor includes a plurality of microreactors arranged in parallel; a flowmeter disposed on a downstream side; a detector detecting a composition of the mixture solution; and a processing device calculating both a reaction time from when the material solutions are mixed up until the detector detects the composition of the mixture solution and an yield of the target product. The processing device includes means for changing the amount of each of the material solutions supplied by the pump in each of the microreactors; means for calculating and storing the reaction time and the yield of the target product for every change in the supply amount; and means for deciding which of the plurality of microreactors is selected on the basis of the reaction time and the yield of the target product.

### BACKGROUND OF THE INVENTION

1. Field of the Invention

The present invention relates to a microreactor system for producing a chemical reaction among at least two solutions in a microchannel of about several tens to several hundreds of micrometers. The present invention is particularly suitable for obtaining optimum conditions and increasing production.

2. Description of the Related Art

During transition time from synthesis in a laboratory to industrial production, it is essential to build and evaluate a pilot plant for scale-up purposes, which however takes lots of time and labor.

It is known that a microreactor can precisely control temperature and reaction time and can cause chemical reaction with high efficiency. Furthermore, it is known that to appropriately adjust various conditions relevant to a chemical reaction of interest in a microchannel of a microchannel chip, e.g., a temperature condition of a reaction region and a concentration, a flow rate and the like of a test reagent, the microreactor samples and analyzes a product obtained from the microchannel, and controls the reaction conditions in the microchannel chip based on the sampling and analysis result. The conventional microreactor is disclosed in, for example, Japanese Patent Application Laid-Open No. 2006-145516.

When a next treatment solution is to be obtained by changing a type and a mixture ratio of solutions, the micro-fluid chip is replaced by another chip for every treatment in order to prevent remaining solutions of a previous treatment from getting mixed. It is known that a clamp is provided to fixedly brace a micro-fluid chip together by its opposing sides so that different types of solutions are supplied to the micro-fluid chip. This technique is disclosed in, for example, Japanese Patent Application Laid-Open No. 2006-102650.

Furthermore, it is known that a predetermined number of microchips are integrally stacked so as to enable synthesis of a large quantity of compounds using the microchips and achieve the high efficiency in chemical reaction. The technique is disclosed in, for example, Japanese Patent Application Laid-Open No. 2002-292275.

According to the technique disclosed in the Japanese Patent Application Laid-Open No. 2006-145516, the chemical reaction is produced by the single microreactor. Due to this, it is disadvantageously difficult to secure productivity necessary for practical production by the production volume of matters obtained by the microreactor that can provide only a small reaction situation.

Furthermore, according to the technique disclosed in the Japanese Patent Application Laid-Open No. 2006-102650, it is disadvantageously necessary to replace one micro-fluid chip by another chip whenever a treatment is carried out. For working mass-production, it takes a large number of man-hours, resulting in cost increase.

Moreover, the technique disclosed in the Japanese Patent Application Laid-Open No. 2002-292275 is intended simply to increase production, and is inappropriate to optimize a channel structure of the microreactor itself, and to change reaction conditions such as reaction temperature with respect to each microreactor.

### SUMMARY OF THE INVENTION

It is an object of the present invention to provide a microreactor system capable of solving the conventional problems, facilitating transition from laboratory-basis synthesis to industrial production, and ensuring quite high-speed and highly efficient production using the microreactors.

According to one aspect of the present invention, there is provided a microreactor system including a microreactor having a microchannel for mixing up two solutions as material solutions to obtain a target product; a material tank for storing each of the material solutions introduced into the microreactor; a pump for supplying each of the material solutions to the microreactor; a temperature control device for setting a temperature of the microreactor; and a mixture solution tank for collecting a mixture solution obtained by the microreactor, the microreactor system including: a plurality of the microreactors arranged in parallel; a flowmeter disposed on a downstream side of each of the microreactors; a detector for detecting a composition of the mixture solution obtained by each of the microreactors as a detection intensity; and a processing device for controlling an amount of each of the material solutions supplied by the pump, for receiving both a value indicating a flow rate measured by the flowmeter and a value indicating the detection intensity detected by the detector, and for calculating both a reaction time from when the material solutions are mixed up until the detector detects the composition of the mixture solution and an yield of the target product, wherein the processing device includes means for changing the amount of each of the material solutions supplied by the pump, in each of the microreactors; means for calculating and storing the reaction time and the yield of the target product for every change in the supply amount; and means for deciding which of the plurality of microreactors is selected on the basis of the reaction time and the yield of the target product stored.

According to the present invention, the chemical reaction apparatus in which a plurality of microreactors is arranged in parallel can simultaneously produce a plurality of reactions different in reaction condition, can calculate reaction results as yields of products, and can automatically compare the yields among channels. It is possible to ensure considerably high-speed and highly efficient production using the microreactors, and to facilitate transition from laboratory-basis synthesis to industrial production.

### BRIEF DESCRIPTION OF THE DRAWINGS

FIG. 1 is a block diagram showing a microreactor system according to an embodiment of the present invention;

FIGS. 2A, 2B and 2C are graphs showing yield versus reaction time according to an embodiment of the present invention;

FIG. 3 is a block diagram showing that the microreactor system shown in FIG. 1 is adapted to mass production;

FIG. 4 is a flowchart of a processing performed during a parameter survey according to an embodiment of the present invention;

FIG. 5 is a flowchart of operation using the microreactor system shown in FIG. 3; and

FIG. 6 is a block diagram showing the parameter survey using a channel inside diameter as a parameter according to an embodiment of the present invention.

### DESCRIPTION OF THE PREFERRED EMBODIMENTS

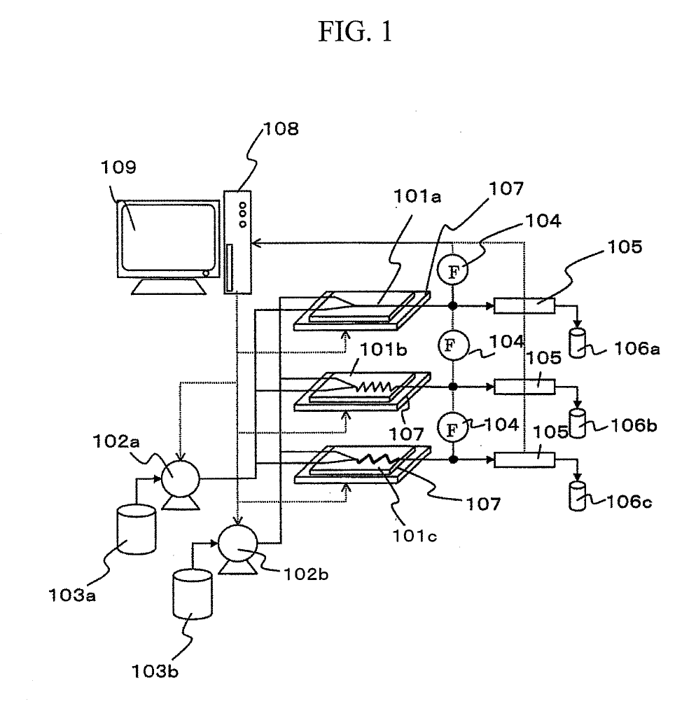

An embodiment of the present invention will be described hereinafter in detail with reference to FIGS. 1 to 6.

FIG. 1 shows a configuration of a microreactor system in which microreactors are arranged in parallel. Namely, three microreactors 101 are arranged in parallel. The microreactors 101 are connected to their respective channels in front and rear thereof by joints or the like (not shown), thereby making them detachable and replaceable. A solution in each of material tanks 103 is supplied to the microreactors 101 arranged in parallel by corresponding pumps 102. The microreactors 101a, 101b, and 101c differ in channel structure.

To mix up three or more solutions, the material tanks 103 and the pumps 102 are prepared for the number corresponding to that of types of the mixed solutions. By providing microreactors 101 having channel structures to mix up three or more solutions, the microreactor system can be configured in a similar fashion to that for mixture of two solutions.

A flowmeter 104 and a detector 105 are provided in a rear channel of each of the microreactors 101. The detector 105 detects a solute composition of a mixture solution mixed up in each microreactor 101 and is preferably a detector based on absorption spectrometry, a detector based on photothermal conversion spectroscopy, or the like. The flowmeter 104 and the detector 105 are electrically connected to a processing device 108 and a detection value is supplied to the processing device 108.

The processing device 108 calculates reaction time from both a flow rate measured by the flowmeter 104 and a channel volume from the microreactor 101 to the detector 105, calculates a reaction ratio of a material in a mixture solution from a solution composition of both materials and a product detected by the detector 105, and calculates yields of the product and a byproduct, and stores therein calculated values as data.

The processing device 108 includes a flow control function for the pumps 102 and a temperature control function for temperature control devices 107.

Each of the temperature control devices 107 functions to keep a temperature of each of the microreactors 101 constant, and is preferably a temperature-controlled bath, a Peltier, or the like. It is also preferable to use a light irradiation device (not shown) such as an optical fiber, a microwave irradiation device (not shown) or the like together with or independently of the temperature control device 107 so as to control or promote a reaction in the microreactor 101.

A reaction efficiency evaluation with respect to each of the microreactors 101 using the microreactor system shown in FIG. 1 will be described in detail.

Suppose that the flow rate detected by the flowmeter 104 is Q and the channel volume from the microreactor 101 to the detector 105 is V. A reaction time t_{R} from mixture of solutions until detection is represented by t_{R}=V/Q.

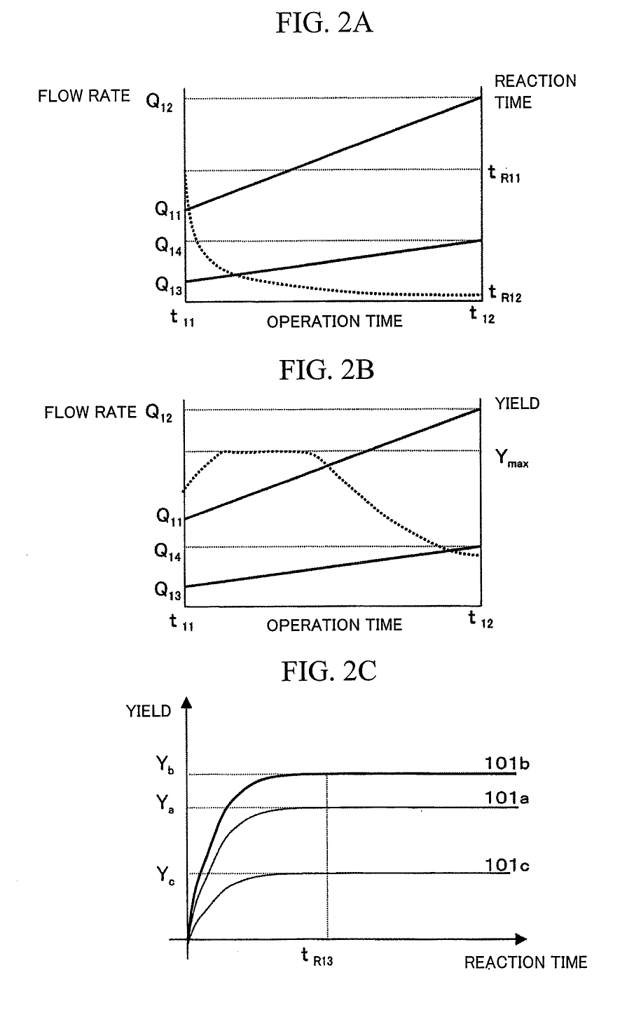

As shown in FIG. 2A, when the flow rate of each of the solutions supplied by the respective pumps 102 during from operation time t₁₁ to t₁₂ is changed from Q₁₁ to Q₁₂, a flow rate detected by the flowmeter 104 is changed from Q₁₃ to Q₁₄, and the reaction time t_{R} decreases from t_{R11} to t_{R12} in inverse proportion to the flow rate.

Using the value detected by the detector 105, a reaction ratio of each material or yields of a target product and a byproduct based on a difference in detection intensity between the materials and the product can be calculated. If the pump flow rate is changed similarly to FIG. 2A, the yields are changed as shown in FIG. 2B.

FIG. 2C is a graph showing the relationship between reaction time and the yield of the target product in the case of the microreactor system shown in FIG. 1 in which three microreactors 101 having the different channel structures are arranged in parallel. In FIG. 2C, Yₐ, Y_{b}, and Y_{c} indicate yields in the microreactors 101a, 101b, and 101c, respectively.

A reaction produced by the microreactor 101 is influenced by the channel structure and a channel width of the microreactor 101. Thus, since the reaction ratio of the materials or the yields of the target product and byproduct in the different microreactors can be calculated as shown in FIG. 2C, reaction efficiencies among the different microreactors can be compared. In the example shown in FIG. 2C, the reaction efficiency is high when the microreactor 101b is used and the reaction time is set to t_{R13} or more. Furthermore, if a plurality of microreactors 101 are used and reaction conditions, e.g., temperature condition are changed with respect to each channel, it is possible to decide efficient reaction conditions.

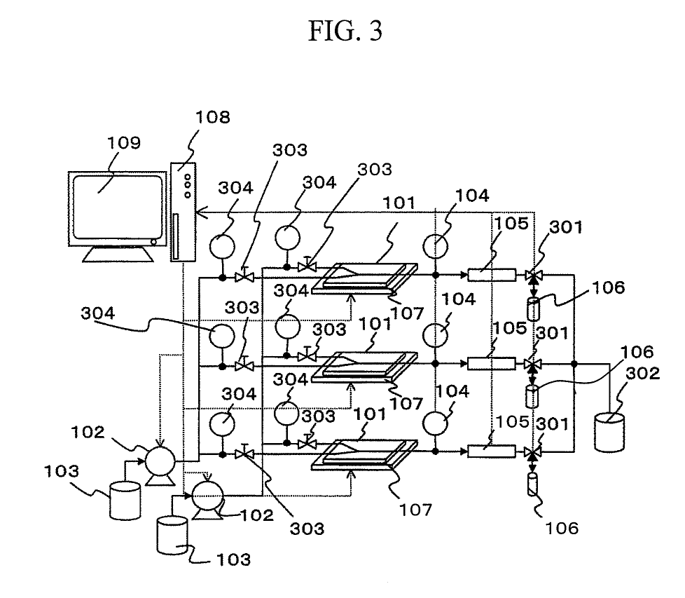

FIG. 3 shows a configuration of a microreactor system according to another embodiment of the present invention. The microreactor system shown in FIG. 3 is configured, as compared with the microreactor system shown in FIG. 1, such that rear channels of the microreactors 101 are joined together and a three-way solenoid valve is used for channel switching.

Each of the microreactors 101 is detachable and replaceable, a three-way solenoid valve 301 is disposed in rear of each of the detectors 105, and rear channels of the three-way solenoid valves 301 are joined together, and a produced solution tank 302 is arranged at a downstream end of the joined channels. The three-way solenoid valves 301 are switched by the processing device 108.

As for an introduction part from a channel branching portion in rear of each pump 102 to each microreactor 101 and a piping from the rear channel of the microreactor 101 to a channel joint portion of the three-way solenoid valve 301 corresponding to the microreactor 101, when the microreactors 101 identical in channel structure are arranged, it is preferable to set their piping equal to each other in length and diameter among the microreactors 101 so as to make flow rates of the microreactors 101 equal to each other. A needle valve 303 is installed in each piping, and a channel sensor 304 detecting a flow rate or a pressure is disposed in a front channel of the needle valve 303. The needle valves 303 regulate the flow rates based on detection values of their channel sensors 304, thereby making it possible to uniformly supply solutions to their respective channels.

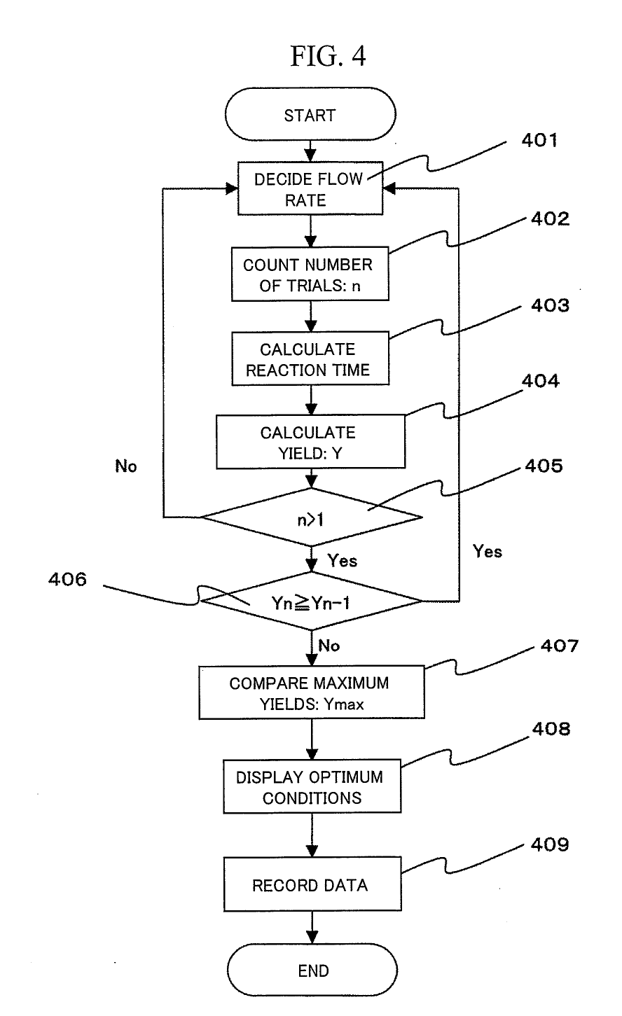

A parameter survey using the microreactor system shown in FIG. 1 or FIG. 3 and an example of a processing flow of the processing device 108 will be described with reference to FIGS. 2A to 2C, FIG. 3, and a flowchart of FIG. 4.

First, a parameter survey using the yield of the target product as an evaluation criterion will be described. Examples of parameters or conditions changed with respect to each channel include a channel width, a channel structure, and a reaction temperature of each microreactor 101. At least one parameter differs among the channels.

An overall flow rate is decided (step 401) and each pump 102 is started. Thereafter, the number of trials n is counted (step 402), and for each of branch channels, reaction time is calculated from both the value of its flowmeter 104 and the channel volume from its microreactor 101 to its detector 105 (step 403).

For each of the branch channels including their respective microreactors 101, an yield Y of its microreactor 101 is calculated based on an input value to its detector 105 (step 404). The yield is recorded only if the number of trials n is 1, and the processing returns to the step 401 of deciding the overall flow rate.

The overall flow rate at the second and following trials is made to always increase or decrease with respect to the previous flow rate. At the second and following trials, the processing device 108 compares the yield Yₙ₋₁ at the previous trial with the yield Yₙ, for each of the branch channels including their respective microreactors 101 (step 406). If the yield Yₙ is almost equal to or higher than the yield Yₙ₋₁ for at least one of the branch channels as a result of comparison, the processing is returned to the step 401 of deciding the overall flow rate and the next trial is carried out.

If the yield Yₙ is obviously lower than the yield Yₙ₋₁ for all of the branch channels including their respective microreactors 101 as a result of the comparison, comparisons are made among maximum yields Yₘₐₓ each of which has been obtained through the trials carried out so far for its individual branch channel including its microreactor 101 (step 407). The channel for which the maximum yield has been obtained, and the flow rate and reaction time (if calculated at the step 403 of calculating the reaction time) at the trial at which the maximum yield has been obtained are displayed as optimum conditions (step 408). The flow rate, the reaction time, and the yields are recorded as data (step 409), thus finishing the processing.

If a parameter survey using the magnitude of reaction ratio of each material or the magnitude of yield of the byproduct as an evaluation criterion is to carried out, judgments and processings at and after the step 406 of comparing the yield Yₙ₋₁ at the previous trial with the yield Yₙ are performed as follows differently from the parameter survey using the magnitude of the yield of the target product.

At the step 406, if the yield Yₙ is nearly equal to or lower than the yield Yₙ₋₁ for at least one of the branch channels as a result of the comparison, the processing is returned to the step 401 of deciding the overall flow rate and the next trial is carried out. If the yield Yₙ is obviously higher than the yield Yₙ₋₁ for all of the branch channels including the respective microreactors 101 as a result of the comparison, comparisons are made among minimum yields Yₘᵢₙ each of which has been obtained through the trials carried out so far for its individual branch channel including its microreactor 101. The channel for which the minimum reaction ratio or yield has been obtained, and the flow rate and the reaction time (if calculated at the step 403 of calculating the reaction time) at the trial at which the minimum reaction ratio or yield has been obtained are displayed as optimum conditions (step 408). The flow rates, the reaction time, and the yields are recorded as data (step 409), thus finishing the processing.

The microreactor system shown in FIG. 1 or FIG. 3 and the use of the system based on the process flow of FIG. 4 facilitate simultaneously changing channel widths, channel shapes, reaction temperatures, and reaction time which serve as parameters necessary to consider in the proving tests for the microreactors 101. Moreover, if the optimum conditions are obtained by the proving tests, then the microreactors 101 included in the microreactor system shown in FIG. 3 are detached and replaced such that a plurality of microreactors 101 identical in channel structure to the microreactor 101 connected to the branch channel for which the optimum conditions have been obtained, are arranged in parallel, thereby increasing production and carrying out continuous operation.

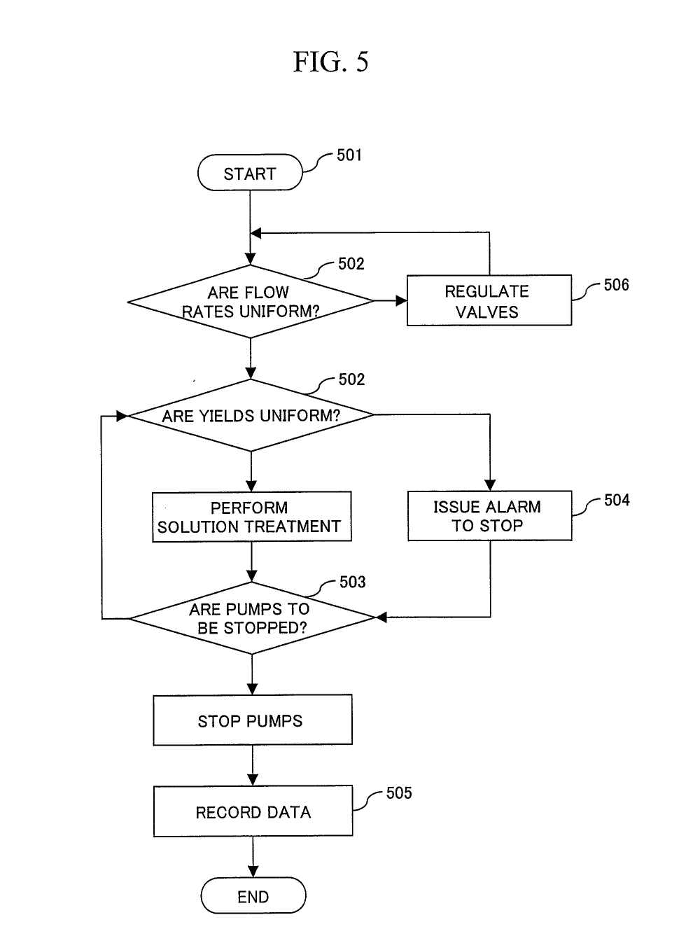

An operation flow for continuous production using the identical microreactors 101 will next be described with reference to FIGS. 3 and 5.

The processing device 108 controls the pumps 102 and the temperature control devices 107 to operate at preset flow rates and temperatures, respectively. Thereafter, it is checked whether the solutions are equally supplied to their respective channels, on the basis of the values detected or measured by the channel sensors 304 and the flowmeters 104 (step 501). If it is determined that the solutions are not uniformly supplied to their respective channels, that is, the values of the channel sensors 304 or the flowmeters 104 differ among the channels, the needle valves 303 are operated to regulate the flow rates (step 506).

If it is determined that the flow rates are uniform among the channels, it is determined whether detection values for the solute compositions from the detectors 105 are uniform among the channels (step 502). If the input values are not uniform, that is, the channels have irregular reaction efficiencies, there is a probability of some abnormality in the channels. Therefore, the processing device 108 displays an alarm (step 504). If it is determined that the pumps 102 are to be stopped (step 503) and the processing device 108 receives an instruction to stop the pumps 102, the flow rates, the reaction time, and the yields at the trials are recorded (step 505), thus finishing the processing.

If the input values are uniform, operation is continued. If it is determined that the pumps 102 are not to be stopped (step 503) and the processing device 108 is not given the instruction to stop the pumps 102, the processing is returned again to the step 502 of determining whether detection values for the solute compositions from the detectors 105 are uniform among the channels, thereby repeatedly monitoring the channels and continuously operating the pumps 102. If the instruction to stop the pumps 102 is received as a result of the step 503 of determining whether to stop the pumps 102, the flow rates, the reaction time, and the yields at the trials are recorded (step 505), thus finishing the processing.

Moreover, if it is determined at the step 502 that the detection values for the solute compositions from the detectors 105 are not uniform among the channels, the processing device 108 switches the three-way solenoid valves 301 in rear of their respective detectors 105 from the produced solution tank 302 side to the mixture solution tank 106 side. Conversely, if it is determined at the step 502 that the detection values for the solute compositions from the detectors 105 are uniform among the channels, the processing device 108 switches the three-way solenoid valves 301 in rear of their respective detectors 105 from the mixture solution tank 106 side to the produced solution tank 302 side. These operations make it possible to keep qualities of products constant in the production using a plurality of microreactors 101.

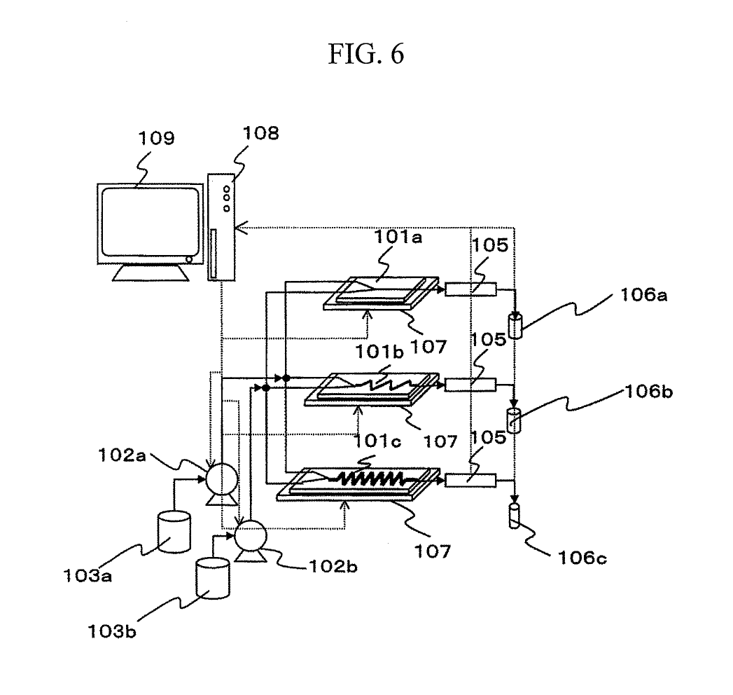

Referring next to FIG. 6, an example of a parameter survey using an inside diameter of each of the channels corresponding to their respective microreactors 101 as a parameter will be described. As for each of the microreactors 101, a channel cross section of a mixing portion where solutions mix together is a circular tube shape. If it is defined that channel inside diameters for the microreactors 101a, 101b, and 101c are dₐ, d_{b}, and d_{c} and channel lengths therefor are lₐ, l_{b}, and l_{c}, the microreactors 101 for which the relationships of dₐ=nd_{b}=md_{c} and lₐ=nl_{b}=ml_{c} are satisfied simultaneously, i.e., for each combination of the two taken from the microreactors 101, its ratio between their channel inside diameters are equal to that between their channel lengths, are connected to the system.

The material solutions supplied by their respective pumps 102 are distributed from their channel branching portions of the channels in front of microreactors 101 to their branch channels. At this time, the solutions supplied to their respective branch channels are distributed such that the flow rates satisfy ΔPₐ=ΔP_{b}=ΔP_{c}, where ΔP indicates a pressure loss of each branch channel. This pressure loss ΔP is defined as ΔP=32 ρlv/d², where ρ is a viscosity of each solution, l is a channel length, v is a flow velocity, and d is a channel inside diameter. Accordingly, the relationship of vₐ=nv_{b}=mv_{c} is deduced from the equation of ΔP=32 ρlv/d² for the flow velocity v in the mixture channel of each microreactor 101.

Meanwhile, the reaction time t_{R} for the mixture channel of each microreactor 101 is expressed by t_{R}=l/v. Therefore, if the relationships of dₐ=nd_{b}=md_{c} and lₐ=nl_{b}=ml_{c} are simultaneously satisfied for the channel inside diameters and the channel lengths of microreactors 101, respectively, the relationship of t_{Ra}=t_{Rb}=t_{Rc} is satisfied for the reaction times t_{Ra}, t_{Rb}, and t_{Rc} for their respective microreactors 101a, 101b, and 101c. In other words, when, for each combination of the two taken from the microreactors 101a, 101b, and 101c, its ratio between their channel inside diameters d is set equal to that between their channel lengths l, it is possible to make the reaction times for their respective microreactors 101a, 101b, and 101c equal to each other.

Therefore, by arranging the microreactors 101a, 101b, and 101c, for each combination of the two taken from which its ratio between their channel inside diameters is equal to that between their channel lengths, into the microreactor system shown in FIG. 6, and by arranging their respective detectors 105 in the rear channels of the microreactors 101, reaction efficiencies can be simultaneously measured while making their reaction times equal to each other in spite of the differences in reaction efficiency among the microreactors 101 having different channel widths, and can be displayed on a monitor 109.

To improve measurement reliability, it is preferable to make efforts to make the piping as short as possible and to make inside diameters of the piping as large as possible so that the pressure loss of the introduction part from the channel branching portion in rear of each pump 102 to each microreactor 101 and that of the piping from the rear channel of the microreactor 101 to the channel joint portion of the three-way solenoid valve 301 corresponding to the microreactor 101 are sufficiently lower than the pressure loss of the mixing portion of each microreactor 101.

While the flowmeters 104, the needle valves 303, and the channel sensors 304 shown in FIG. 3 are not always necessary, it is preferable to arrange them so as to monitor states of the channels and to improve the reliability of the microreactor system.

A processing flow of the processing device 108 when a parameter survey for which the channel inside diameters are changed is carried out for the microreactor system shown in FIG. 6 is executed according to the flowchart of FIG. 4 similarly to the microreactor systems shown in FIGS. 1 and 3. If the flowmeter is not arranged in the channel including each microreactor 101 in the microreactor system shown in FIG. 6, the reaction time is calculated at the step 402 by dividing a sum Vsum of volumes of the respective microreactors 101 by the overall flow rate Q of the microreactor system shown in FIG. 6.

Moreover, since the microreactors 101 are connected to the channels in front and rear of the respective microreactors 101 by joints or the like (not shown), the microreactors 101 and the front and rear channels are made detachable and replaceable. Besides, by arranging the three-way solenoid valves 301, the produced solution tank 302, the needle valves 303, and the channel sensors 304 similarly to the microreactor system shown in FIG. 3, the continuous production can be performed similarly to the operation flow of FIG. 5.

What is claimed is:

1. A microreactor system including a microreactor having a microchannel for mixing up two solutions as material solutions to obtain a target product; a material tank for storing each of the material solutions introduced into the microreactor; a pump for supplying each of said material solutions to the microreactor; a temperature control device for setting a temperature of said microreactor; and a mixture solution tank for collecting a mixture solution obtained by the microreactor, the microreactor system comprising:
a plurality of the microreactors arranged in parallel;
a flowmeter disposed on a downstream side of each of the microreactors;
a detector for detecting a composition of the mixture solution obtained by each of the microreactors as a detection intensity; and
a processing device for controlling an amount of each of the material solutions supplied by the pump, for receiving a value indicating a flow rate measured by said flowmeter and a value indicating the detection intensity detected by said detector, and for calculating both a reaction time from when said material solutions are mixed up until said detector detects the composition of the mixture solution and an yield of said target product,
wherein said processing device includes:
means for changing the amount of each of the material solutions supplied by said pump, in each of said microreactors;
means for calculating and storing said reaction time and the yield of said target product for every change in the supply amount; and
means for deciding which of said plurality of microreactors is selected on the basis of said reaction time and the yield of said target product.

2. The microreactor system according to claim 1, wherein each of said microreactors is detachable.

3. The microreactor system according to claim 1,
wherein each of said microreactors is displaceable, and
a plurality of microreactors identical in channel structure to said microreactor decided to be selected is connectable in parallel.

4. The microreactor system according to claim 1,
wherein each of said microreactors is displaceable, and
a plurality of microreactors equal in channel length to said microreactor decided to be selected is connectable in parallel.

5. The microreactor system according to claim 1,
wherein a plurality of said microchannels differ in at least one of a channel cross-sectional area and a channel length.

6. The microreactor system according to claim 1,
wherein said microchannels of the plurality of microreactors have circular tube-shaped cross sections, and for each combination of the two taken from the microchannels, its ratio between their channel inside diameters is made equal to that between their channel lengths.

7. The microreactor system according to claim 1, comprising a produced solution tank for joining together and collecting the mixture solution obtained by each of said microreactors.

8. The microreactor system according to claim 1, comprising:
a produced solution tank for joining together and collecting the mixture solution obtained by each of said microreactors; and
a three-way solenoid valve connected to a downstream side of said detector and for switching supply of said mixture solution to said mixture solution tank or to said produced solution tank.
